(19) United States
(12) Patent Application Publication
(10) Pub. No.: US 2010/0102928 A1
(43) Pub. Date: Apr. 29, 2010

(54) Monitoring Apparatus and Operating Method Thereof

(75) Inventor: Chih Yen Chang, Hsinchu Hsien (TW)

Correspondence Address: EDELL, SHAPIRO & FINNAN, LLC, 1901 RESEARCH BOULEVARD, SUITE 400, ROCKVILLE, MD, 20850, US

(73) Assignee: MSTAR SEMICONDUCTOR, INC., Hsinchu Hsien (TW)

(21) Appl. No.: 12/572,425

(22) Filed: Oct. 2, 2009

(30) Foreign Application Priority Data
Oct. 29, 2008 (TW) 097141671

(51) Int. Cl. G06F 7/04; H04Q 5/22; H04N 7/18

(52) U.S. Cl. 340/5.72; 340/10.1; 348/148; 348/E07.087; 340/10.6

(57) ABSTRACT

A monitoring apparatus and the associated method are provided. The monitoring apparatus includes a tag reading module and a control module. The tag reading module accesses a target tag attached to a target object to generate an access signal. The control module is coupled to the tag reading module and receives the access signal. When the control module operates in an alert mode, the control module selectively generates a control signal according to a reading condition of the access signal.

### CROSS REFERENCE TO RELATED PATENT APPLICATION

This patent application is based on Taiwan, R.O.C. patent application No. 97141671 filed on Oct. 29, 2008.

### FIELD OF THE INVENTION

The present invention relates to a monitoring apparatus, and more particularly, to a monitoring apparatus using radio frequency identification (RFID) technology and a method thereof.

### BACKGROUND OF THE INVENTION

RFID is a non-contact automatic identification technology comprising tags and readers. A rather small RFID tag chip is set on or built inside merchandize, and merchandize data stored in the RFID tag chip is transmitted to a reader for identification or tracking purposes via an RFID signal. No manual operation is needed when the RFID technology is used for identification. Therefore, the RFID technology can be applied to factory automation, goods sales, toll systems or vehicle identifications.

Currently an automobile anti-theft monitoring system detects whether a vehicle body is being touched or a window is opened when the vehicle is in an alert mode. Once the vehicle body is being touched or the window is opened, the automobile anti-theft monitoring system enables an alert sound or light, so as to shock a would-be car thief and prevent a theft, as well as to attract attention of the driver or other people.

However, an alert may frequently occur when a conventional automobile anti-theft monitoring system makes an incorrect judgment or the vehicle is unintentionally touched by someone. Such an alert results in a false alarm for the owner of the vehicle and other people. In addition, except for providing an alert in sound or light, the conventional automobile anti-theft monitoring system can not provide related information, such as a current image or a current position of the stolen vehicle, to the owner, a security guard or the police, to facilitate locating the stolen vehicle.

There is therefore a need for improvements in anti-theft systems and methodologies.

### SUMMARY OF THE INVENTION

A monitoring apparatus is provided according to the present invention. The monitoring apparatus comprises a tag reading module and a control module. The tag reading module accesses a target tag attached to a target object to generate an access signal. The control module, coupled to the tag reading module, receives the access signal. When the control module is in an alert mode, the control module selectively generates a control signal according to a reading condition of the access signal.

An operating method of a monitoring apparatus is provided according to an embodiment of the present invention. In this method, an operation mode of the monitoring apparatus is determined according to a mode selecting signal. A target tag attached to a target object is then accessed to generate an access signal. A control signal is selectively generated according to the operation mode and a reading condition of the access signal.

Compared to the prior art, the monitoring apparatus and the operating method thereof according to the present invention can also achieve capabilities of a traditional automobile anti-theft monitoring system. Moreover, the monitoring apparatus and the operating method thereof according to the present invention further implement characteristics of the RFID technology and integrate an image capturing apparatus, a communication transmitting apparatus and a Global Positioning System (GPS). Therefore, information related to a stolen vehicle, such as a current image or a current position, can be timely provided to a user, a security guard or the police. Thus, according to the present invention, a multifunctional and all-round automobile anti-theft monitoring system is provided to the user.

The advantages and spirit related to the present invention can be further understood via the following detailed description and drawings.

### BRIEF DESCRIPTION OF THE DRAWINGS

FIG. 1 is a functional block diagram of a monitoring apparatus according to a first embodiment of the present invention.

FIG. 2 is a functional block diagram of a monitoring apparatus according to a second embodiment of the present invention.

FIG. 3 is a flow chart of an operating method of a monitoring apparatus according to a third embodiment of the present invention.

FIG. 4 is a detailed flow chart of Step S12 illustrated in FIG. 3.

FIG. 5 is an example of an automobile anti-theft monitoring system using a monitoring apparatus according to the present invention.

### DETAILED DESCRIPTION OF THE PREFERRED EMBODIMENT

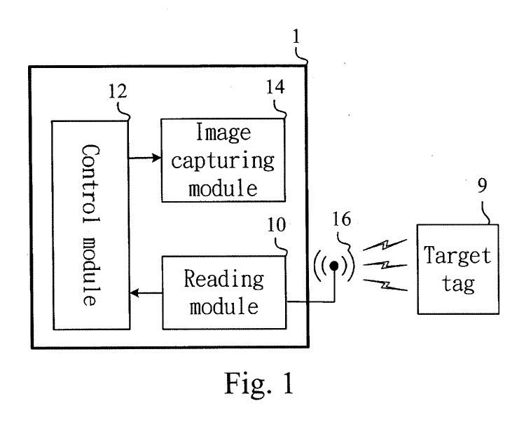

A monitoring apparatus is provided according to the present invention. FIG. 1 shows a functional block diagram of the monitoring apparatus. A monitoring apparatus 1 comprises a tag reading module 10, a control module 12, an image capturing module 14 and an antenna 16. In a practical application, the tag reading module 10 is a high frequency (HF) RFID tag reader. The tag reading module 10 is coupled to the control module 12 via a Serial Peripheral Interface (SPI) or an Inter-Integrated Circuit (I2C) bus. The tag reading module 10 accesses a target tag 9 attached to a target object to generate an access signal. For example, the target object is a windshield of a vehicle, a vehicle door, a vehicle window or an engine hood, and the target tag 9 is an HF RFID tag.

In this embodiment, the control module 12 is coupled to the tag reading module 10. When operating in an alert mode, the control module 12 does not generate a control signal in the event that the access signal transmitted from the tag reading module 10 is received; on the other hand, the control module 12 generates the control signal in the event that no access signal is received.

For example, a vehicle of Mr. Zhang's is equipped with the monitoring apparatus 1, and the target tag 9 is set on an engine hood of the vehicle. After parking the vehicle, Mr. Zhang locks the vehicle and activates the alert mode of the monitoring apparatus 1. Under normal conditions, the engine hood of the vehicle is not moved. Therefore, when the tag reading module 10 accesses the target tag 9 attached to the engine hood at regular intervals, such as five seconds, the tag reading module 10 shall access the target tag 9 and generate the access signal to the control module 12. The access signal transmitted from the tag reading module 10 is received, and hence the control module 12 does not generate the control signal.

However, when the engine hood of the vehicle is opened, the tag reading module 10 can not access the target tag 9, such that the tag reading module 10 can not generate the access signal. Consequently, no access signal from the tag reading module 10 is received, and the control module 12 shall generate the control signal.

In this embodiment, the image capturing module 14, coupled to the control module 12, captures real-time images according to the control signal generated by the control module 12. In practice, the image capturing module 14 is a camera corresponding to an area where the target tag 9 is attached. Once the camera receives the control signal generated by the control module 12, the camera immediately takes a real-time image of the area where the target tag 9 is attached. The real-time image is film or a photograph (or digital versions thereof). In this embodiment, the real-time image taken by the camera, having captured an image of a destroyer or invader, is aimed at providing reference information to the police.

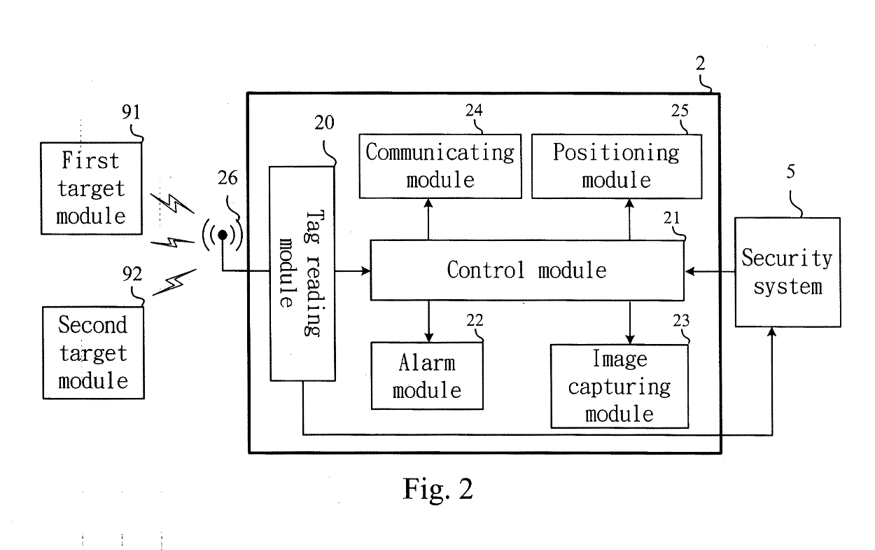

A monitoring apparatus is provided according to a second embodiment of the present invention. FIG. 2 shows a functional block diagram of the monitoring apparatus. A monitoring apparatus 2 comprises a tag reading module 20, a control module 21, an alarm module 22, an image capturing module 23, a communicating module 24 and a positioning module 25.

In a practical application, the tag reading module 20 is an HF/ultra high frequency (UHF) RFID tag reader. Therefore, the tag reading module 20 can access HF RFID tags and UHF RFID tags. Generally speaking, access range of the UHF RFID tag, about several meters, is greater than that of HF RFID tag. The tag reading module 20 is coupled to the control module 21 via an SPI or I2C bus. In addition, the tag reading module 20 and the control module 21 are respectively coupled to a security system 5, which is a keyless entry system of a vehicle in this embodiment.

The tag access module 20 accesses a first target tag 91 attached to a target object via an antenna 26 to generate a first access signal. In practice, the first target tag 91 is an HF RFID tag. The control module 21 is coupled to the tag reading module 20 and the security system 5 set outside the monitoring apparatus 2. The control module 21 receives the first access signal from the tag reading module 20 and generates a control signal according to the first access signal.

For example, the security system 5 generates a mode selecting signal. When receiving the mode selecting signal from the security system 5, the control module 21 selectively operates in a first mode (alert mode) or a second mode (de-alert mode) according to the mode selecting signal. For example, when the security system 5 is the keyless entry system mentioned above, operation principles of a general keyless entry system 5 are as described below. Normally, when no second target tag 92, such as the UHF RFID tag, is near the tag reading module 20, the keyless entry system 5 generates the mode selecting signal, which controls the control module 21 to operate in the first mode (alert mode). When a vehicle key, to which the second target tag 92 is attached, approaches the tag reading module 20, the tag reading module 20 transmits a reading signal and receives a response signal generated by the second target tag 92 via the antenna 26. The tag reading module 20 then confirms that the second target tag 92 passes verification, such as confirming a verification code of the second target tag 92. That is, the vehicle owner is identified. The keyless entry system 5 unlocks the vehicle door and generates the mode selecting signal, which controls the control module 21 to operate in the second mode (de-alert mode).

Under another circumstance, the tag reading module 20 receives the response signal generated by the second target tag 92; however, the second target tag 92 does not pass verification. In order to ensure security of the vehicle, the keyless entry system 5 generates the mode selecting signal, which controls the control module 21 to operate in the first mode (alert mode).

In this embodiment, the control module 21 generates a control signal only when it does not receive the first access signal from the tag reading module 20 while operating in the first mode (alert mode). That is to say, when the control module 21 of the monitoring apparatus 2 determines that the tag reading module 20 fails to access the first target tag 91 while operating in the alert mode, the control module 21 concludes that the target object is moved or destroyed and thus generates the control signal.

For example, the monitoring apparatus 2 is applied to an automobile anti-theft monitoring system and the first target tag 91 is set on a vehicle component, such as a windshield of the vehicle, a vehicle door, a vehicle window or an engine hood. When operating in the alert mode, the tag reading module 20 of the monitoring apparatus 2 transmits a reading signal to the first target tag 91 via the antenna 26 at regular intervals, e.g., one second. Under normal conditions that the first target tag 91 is not moved or destroyed, the first target tag 91 immediately transmits a response signal to the tag reading module 20 upon receiving the reading signal. When receiving the response signal via the antenna 26, the tag reading module 20 immediately generates and transmits a first access signal to the control module 21. When the control module 21 receives the first access signal, it means that the vehicle component to which the first target tag 91 is attached is not destroyed. Therefore, the control module 21 shall not generate the control signal.

Consider an abnormal circumstance that the vehicle component to which the first target tag 91 is moved or destroyed. The tag reading module 20 can not receive the response signal transmitted by the first target tag 91, and hence the tag reading module 20 does not generate the first access signal. When no first access signal is received, the control module 21 immediately determines that the vehicle component to which the target tag 91 is attached is moved or destroyed. Therefore, the control module 21 generates the control signal.

Nevertheless, in order to avoid misjudgments (and, e.g., false alarms), the control module 21 of the monitoring apparatus 2 generates the control signal when the tag reading module 20 fails to read the first target tag 91 for a consecutive number of times, such as three consecutive times.

As described previously, the monitoring apparatus 2 comprises the alert module 22, the image capturing module 23, the communicating module 24 and the positioning module 25. The alert module 22, the image capturing module 23, the communicating module 24 and the positioning module 25 are coupled to the control module 21 and receive the control signal generated by the control module 21. In practice, the communication module 24 is coupled to the control module 21 via a Universal Asynchronous Receiver/Transmitter (UART). The alert module 22 is coupled to the control module 21 via a pulse-code modulation (PCM) interface. The image capturing module 23 is coupled to the control module 21 via a camera interface (CAMIF).

The alert module 22 generates an alert message according to the control signal. For example, a harsh alert sound is played via a speaker or a bright alert light is generated by a light emitting apparatus, so as to communicate an anti-theft alert. The image capturing module 23 captures a real-time image according to the control signal. In practice, the image capturing module 23 is a camera corresponding to an area where the first target tag 91 is attached. Once the camera receives the control signal generated by the control module 21, the camera immediately captures a real-time image of the area where the first target tag 91 is attached. The real-time image is a film or a photograph (or digital imagery).

The communicating module 24 transmits the alert message to a mobile phone of the vehicle owner or a monitoring system of a security service provider or the police. For example, the communicating module 24 is a communicating module of different communication system protocols, such as a Global System for Mobile communications (GSM) communicating module, a Wideband Code Division Multiple Access (WCDMA) communicating module or a third generation (3G) communicating module and so on. The alert message has various possible forms, such as a text message or a multimedia message of the real-time image taken by the image capturing module 23.

The positioning module 25 detects a position of the target object according to the control signal. For example, the positioning module 25 is a GPS. When the vehicle is unfortunately driven away by theft, the monitoring apparatus 2 immediately obtains related information of a real-time position of the vehicle with the help of the positioning module 25. The monitoring apparatus 2 then transmits related information to the vehicle owner, the security service provider or the police via the communicating module 24. Accordingly, a current moving direction of the vehicle is effectively tracked to enable the security service provider or the police to successfully find the stolen vehicle.

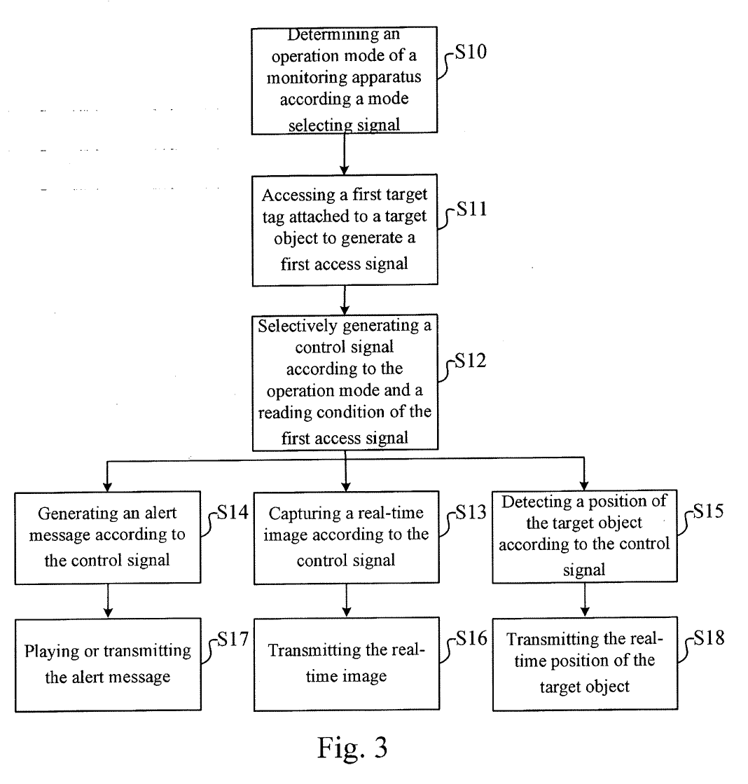

FIG. 3 shows a flow chart of an operating method of a monitoring apparatus. The method begins with Step S10. In Step S10, an operation mode of a monitoring apparatus is determined according a mode selecting signal. In Step S11, a first target tag attached to a target object is accessed to generate a first access signal. For example, when the monitoring apparatus is applied a vehicle, the target object is a vehicle window, a vehicle door, an engine hood or a windshield.

In Step S12, a control signal is selectively generated according to the operation mode and a reading condition of the first access signal. In practice, before Step S10 is executed, a second target tag is accessed to generate a second access signal and a mode selecting signal is generated according to the second access signal. The first target tag is an HF RFID tag, and the second target tag is a UHF RFID tag.

In a practical application, the operation mode comprises a first mode and a second mode. When the second access signal indicates the second target tag passes verification, such as the second access signal comprises a correct verification code, the operation mode of the monitoring apparatus is determined as the second mode according to the mode selecting signal. Otherwise, the operation mode of the monitoring apparatus is determined as the first mode according to the mode selecting signal. For example, the first mode is a monitoring mode or an alert mode, and the second mode is a de-alert mode. In the second mode, the control signal is not generated according to the method.

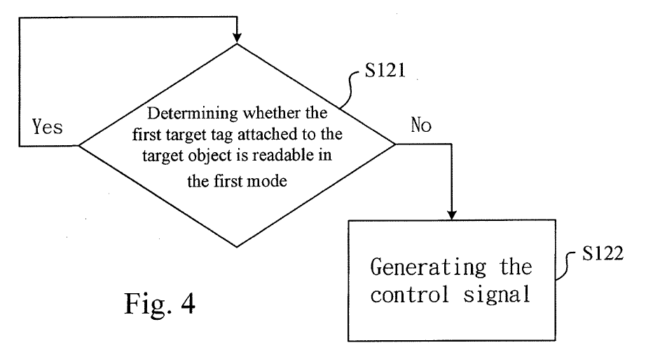

When the operation mode of the monitoring apparatus is the first mode, referring to FIG. 4, Step S12 further comprises Step S121 to Step S122. In Step S121, it is determined whether the control signal is generated according to whether the first target tag attached to the target object is readable. When the result of Step S121 is yes, i.e., when the first target tag attached to the target object is readable, Step S121 is repeated. Otherwise, when the result of Step S121 is no, i.e., when the first target tag attached to the target object is not readable, Step S122 is executed. In Step S122, the control signal is generated.

Referring again to FIG. 3, when the control signal is generated, Step S13 is executed. In Step S13, a real-time image is captured according to the control signal. For example, the real-time image is a film or a digital photograph. After the real-time image is captured in Step S13, Step S16 is executed. In Step S16, the real-time image is transmitted to a vehicle owner, a security service provider or the police.

In this embodiment, after the control signal is generated, Step S14 is executed. In Step S14, an alert message is generated according to the control signal. Step S17 is then executed. In Step S17, the alert message is played or transmitted. For example, when the alert message is in a form of sound or light, the alert message is played by an alert device. When the alert message is in a form of text, the alert message is transmitted using wireless transmission. For example, the alert message is transmitted to a mobile phone of the vehicle owner via a wireless communication system. The alert message can be a multimedia message, such as the real-time image captured as described in Step S13. That is, the real-time image is transmitted to the vehicle owner using wireless transmission.

In addition, after the control signal is generated, Step S15 can be executed. In Step S15, a position of the target object is detected according to the control signal. In practice, related information, such as a real-time position of the target object, e.g., the vehicle, is obtained in Step S15. Step S18 is further executed. In Step S18, related information, such as the real-time position of the target object, obtained in Step S15, is transmitted to the vehicle owner, the security service provider or the police.

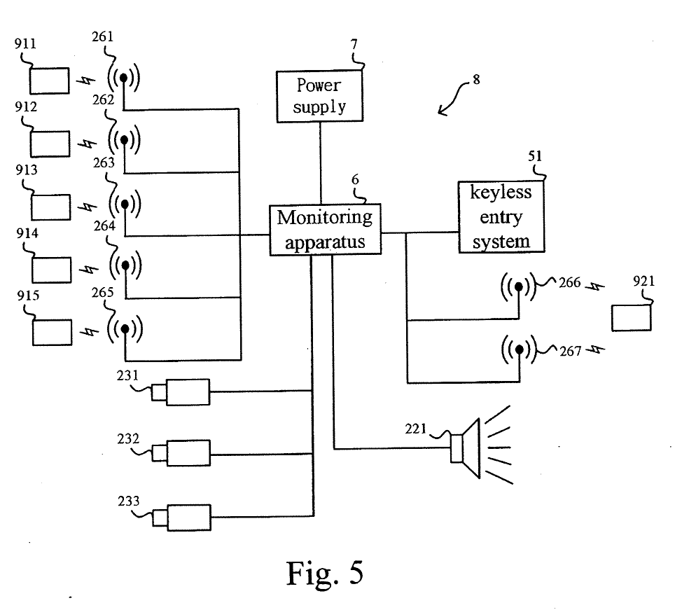

An example of a practical operation of a monitoring apparatus according to the present invention is to be described in detail. Refer to FIG. 5 showing an example of an automobile anti-theft monitoring system using the monitoring apparatus according to the present invention. In this example, a monitoring apparatus 6 is applied to an automobile anti-theft monitoring system 8 to achieve a function of providing an alert that warns on unauthorized entry or vandalism.

Referring to FIG. 5, first target tags 911 to 915, which are HF RFID tags, are attached to a front-left vehicle window, a front-right vehicle window, a rear-left vehicle window, a rear-right vehicle window and an engine compartment. A monitoring apparatus 6 is coupled to HF antennas 261 to 265 corresponding to first target tags 911 to 915 respectively. The access range of the HF RFID tags 911 to 915 is less than one meter. Therefore, each of the HF antennas 261 to 265 is set near the corresponding first target tags 911 to 915. In addition, the monitoring apparatus 6 is coupled to cameras 231 to 233, a power supply 7, a keyless entry system 51, a playing apparatus 221 and UHF antennas 266 to 267 for reading second target tags, such as UHF RFID tags. The power supply 7 provides a power supply to operate the automobile burglarproof monitoring system 8.

When the monitoring apparatus 6 is activated, a tag reading module, not illustrated in FIG. 5, of the monitoring apparatus 6 respectively transmits an access signal to the corresponding HF RFID tags 911 to 915 at regular intervals, such as one second. A normal circumstance and an abnormal circumstance are to be described as below.

Under normal conditions, areas of all the HF RFID tags 911 to 915 are not moved or destroyed. Therefore, each of the HF RFID tags 911 to 915 respectively receives the access signal from the monitoring apparatus 6 via the HF antennas 261 to 265 and transmits a response signal to the monitoring apparatus 6 according to the access signal. According to whether a certain HF RFID tag, such as the first target tag 911 of the front-left vehicle window, receives the response signal, the monitoring apparatus 6 then determines whether the first target tag 911 of the front-left vehicle window is accessed.

That is to say, the monitoring apparatus 6 can receive the response signal transmitted by the first target tag 911 of the front-left vehicle window, meaning that the area, i.e., the front-left vehicle window, where the first target tag 911 of the front-left vehicle window is attached, is not moved or destroyed. Therefore, the monitoring apparatus 6 can receive the response signals transmitted by the HF RFID tags 911 to 915, indicating that the areas where all the HF RFID tags 911 to 915 are attached are not moved or destroyed.

An operation of the automobile anti-theft monitoring system 8 under the abnormal circumstance is to be described. When the first target tag 911 of the front-left vehicle window is moved or destroyed, the first target tag 911 of the front-left vehicle window can not receive the access signal transmitted by the monitoring apparatus 6 at regular intervals. Consequently, the first target tag 911 of the front-left vehicle window can not transmit the response signal to the monitoring apparatus 6 according to the access signal. The monitoring apparatus 6 can not receive the response signal transmitted by the first target tag 911 of the front-left vehicle window, meaning that the area of the front-left vehicle window, where the first target tag 911 of the front-left vehicle window is attached, is moved or destroyed. However, in a practical application, in order to make sure the abnormal circumstance is not misjudged, the monitoring apparatus 6 is programmed to generate the control signal only when detection of the first target tag 911 at the front-left window fails for at least three consecutive times.

The cameras 231 to 233 are used for taking real-time images of corresponding areas according to the control signal. The camera 231 corresponds to the area of the front-left window and the rear-left window of the vehicle, the camera 232 corresponds to the area of the front-right window and the rear-right window of the vehicle, and the camera 233 corresponds to the area of the engine compartment of the vehicle. The playing apparatus 221 plays an alert sound according to the control signal. The monitoring apparatus 6 further comprises the foregoing control module, alert module, image capture module, communicating module and positioning module, so as to take emergency measures according to the control signal. Functions of the modules are specifically described as above and shall not be discussed for brevity.

In this example, the keyless entry system 51 is coupled to the monitoring apparatus 6 and the UHF antennas 266 and 267. The UHF antennas 266 and 267 are used for reading the second target tag 921. The UHF antenna 266 is set inside the vehicle and the UHF antenna 267 is set inside the engine compartment of the vehicle. Generally, the second target tag 921 is set inside a key or a reading card of the vehicle owner. For example, when approaching the vehicle, the second target tag 921 receives a reading signal transmitted by the keyless entry system 51 via the UHF antenna 266 or 267 and generates a response signal. The keyless entry system 51 shall determine whether the second target tag 921 passes verification, such as confirming a verification code of the second target tag 921. When the second target tag 921 passes the verification, it means that the vehicle owner is identified, and the keyless entry system 51 then de-alerts the vehicle. When the second target tag 921 does not pass verification, the keyless entry system 51 shall operate in the alert mode for security.

Compared to the prior art, the monitoring apparatus and the operating method thereof according to the present invention can also achieve capabilities of a traditional automobile anti-theft monitoring system. Moreover, the monitoring apparatus and the operating method thereof according to the present invention further implement characteristics of the RFID technology and integrate an image capturing apparatus, a communication transmitting apparatus and a Global Positioning System (GPS). Therefore, information related to a stolen vehicle such as a current image or a current position is timely provided to a user, a security service provider or the police. Therefore, according to the present invention, a multifunctional and all-round automobile anti-theft monitoring system is provided to the user.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A monitoring apparatus, comprising:
a tag reading module, for accessing a first target tag attached to a target object to generate a first access signal; and
a control module, coupled to the tag reading module, for receiving the first access signal, and selectively generating a control signal according to a reading condition of the first access signal when operating in a first mode.

2. The monitoring apparatus as claimed in claim 1, the tag reading module for further accessing a second target tag to generate a second access signal, the monitoring apparatus further comprising:
a security system, coupled to the tag reading module and the control module, for generating a mode selecting signal according to the second access signal;
wherein the mode selecting signal determines whether the control module operates in the first mode or a second mode, and the control module does not generate the control signal when the control module operates in the second mode.

3. The monitoring apparatus as claimed in claim 2, wherein the first target tag is a high frequency (HF) radio frequency identification (RFID) tag, and the second target tag is an ultra high frequency (UHF) RFID tag.

4. The monitoring apparatus as claimed in claim 2, applied to a vehicle, wherein the security system is a keyless entry system of the vehicle.

5. The monitoring apparatus as claimed in claim 1, further comprising:
an alert module, coupled to the control module, for generating an alert message according to the control signal.

6. The monitoring apparatus as claimed in claim 1, further comprising:
an image capturing module, coupled to the control module, for capturing a real-time image according to the control signal.

7. The monitoring apparatus as claimed in claim 1, further comprising:
a communicating module, coupled to the control module, for transmitting an alert message according to the control signal.

8. The monitoring apparatus as claimed in claim 7, wherein the communicating module is a Global System for Mobile communications (GSM) module, a Wideband Code Division Multiple Access (WCDMA) module or a third generation (3G) module.

9. The monitoring apparatus as claimed in claim 7, further comprising:
an image capturing module, coupled to the control module, for capturing a real-time image according to the control signal, wherein the alert message comprises the real-time image.

10. The monitoring apparatus as claimed in claim 1, further comprising:
a positioning module, coupled to the control module, for detecting a position of the target object according to the control signal.

11. The monitoring apparatus as claimed in claim 1, applied to a vehicle, wherein the target object is a vehicle window, a vehicle door, an engine hood or a windshield of the vehicle.

12. An operating method of a monitoring apparatus, comprising steps of:
(a) determining an operation mode of the monitoring apparatus according to a mode selecting signal;
(b) accessing a first target tag attached to a target object to generate a first access signal; and
(c) selectively generating a control signal according to the operation mode and a reading condition of the first access signal.

13. The operating method as claimed in claim 12, further comprising:
(d) accessing a second target tag to generate a second access signal; and
(e) generating the mode selecting signal according to the second access signal.

14. The operating method as claimed in claim 13, wherein the operation mode comprises a first mode and a second mode; when the second access signal indicates the second target tag passes verification, the mode selecting signal determines the operation mode is the second mode, in which the control signal is not generated, else the mode selecting signal determines the operation mode is the first mode.

15. The operating method as claimed in claim 13, wherein the first target tag is an HF RFID tag, and the second target tag is a UHF RFID tag.

16. The operating method as claimed in clam 12, further comprising:
(f) generating an alert message according to the control signal.

17. The operating method as claimed in clam 12, further comprising:
(g) capturing a real-time image according to the control signal.

18. The operating method as claimed in clam 12, further comprising:
(h)transmitting an alert message via wireless transmission according to the control signal.

19. The operating method as claimed in claim 18, further comprising:
(i) capturing a real-time image according to the control signal, wherein the alert message comprises the real-time image.

20. The operating method as claimed in claim 12, further comprising:
(j) detecting a position of the target object according to the control signal.
